(19) United States
(12) Patent Application Publication
(10) Pub. No.: US 2014/0187760 A1
(43) Pub. Date: Jul. 3, 2014

(54) Lignin Precipitation Methods

(71) Applicant: WEYERHAEUSER NR COMPANY, Federal Way, WA (US)

(72) Inventor: Qiusheng Pu, Auburn, WA (US)

(73) Assignee: WEYERHAEUSER NR COMPANY, Federal Way, WA (US)

(21) Appl. No.: 13/730,218

(22) Filed: Dec. 28, 2012

(51) Int. Cl. C07G 1/00

(52) U.S. Cl. CPC C07G 1/00
USPC 530/507

(57) ABSTRACT

A method of separating lignin from black liquor from a pulp mill by adjusting the pH of the black liquor is provided. Various additional steps can be used to further process the separated lignin, including washing, drying, and/or comminuting. In certain embodiments, solvents and byproducts are recycled so as to reduce waste and maintain chemical balance within a commercial lignin production facility.

### BACKGROUND

Lignin is found in the cell walls of vascular plants and in the woody stems of hardwoods and softwoods. Along with cellulose and hemicellulose, lignin forms the major components of the cell wall of these vascular plants and woods. Lignin acts as a matrix material that binds the plant polysaccharides, microfibrils, and fibers, thereby imparting strength and rigidity to the plant stem. Total lignin content can vary from plant to plant. For example, in hardwoods and softwoods, lignin content can range from about 15% to about 40%.

Hardwoods are angiosperms. Exemplary hardwoods include aspen, ash, alder, basswood, beech, birch, chestnut, cottonwood, elm, eucalyptus, gum, magnolia, maple, poplar and tulip. Softwoods are gymnosperms. Exemplary softwoods include cedar, Douglas fir, fir, hemlock, larch, pine and spruce. Either hardwoods or softwoods can be used as the starting raw material for lignin. Other exemplary lignin sources include pulps from kenaf and grasses.

Wood pulping is one process for removing lignin and is one of the largest industries in the world. Wood pulping results in large amounts of lignin being extracted from the wood.

One type of wood pulping process is the kraft or sulfate pulping process. There is a difference in the lignin that is obtained depending on the process used to separate the lignin from the cellulose. Soda pulping and sulfate pulping will react differently with the lignin and produce different lignin products. The soda process uses sodium hydroxide as the cooking chemical in the cooking liquor. Anthraquinone can be added in soda pulping to enhance the process efficiency. The kraft or sulfate process uses sodium hydroxide and sodium sulfide as the cooking chemicals in the cooking liquor. Polysulfide can be added in the kraft process to increase pulp yield. These different cooking chemicals will react with the lignin differently. The purpose of the pulping process is to separate the lignin and the hemicelluloses from the cellulose. During the cooking process the lignin and hemicelluloses are solubilized by the cooking chemicals and migrate from the wood chip to the cooking liquor. At the end of the pulp cook the spent cooking liquor with its load of organic material, including lignin and hemicellulose sugars, and inorganic cooking chemicals is separated from the cellulose. The spent cooking liquor from the kraft or sulfate process is called black liquor.

The extracted lignin has generally been considered to be waste, and traditionally is either burned to recover energy or otherwise disposed of. Only a small amount of lignin is recovered and processed to make other products. Efforts are now underway to utilize this lignin, motivated by its widespread availability and the renewable nature of its source. As lignin becomes an increasingly important product, new methods for its production are desired.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a method of separating lignin from black liquor is provided. In one embodiment, the method includes the steps of:

(a) adjusting the pH of the black liquor to between about 8.5 and about 10.0 to provide a basic lignin suspension;

(b) displacing liquid from the basic lignin suspension with a first water solution to provide dirty cake lignin;

(c) comminuting the dirty cake lignin with a comminuting acidic material to provide an acidic lignin suspension having a pH between about 1.5 and about 6.0 and an ion concentration between about 0.1 and about 0.5 M; and

(d) precipitating the acidic lignin suspension to provide lignin solids.

In another aspect, a method of separating lignin from black liquor is provided. In one embodiment, the method includes the steps of:

(a) adjusting the pH of the black liquor to between about 8.5 and about 10.0 to provide a basic lignin suspension;

(b) displacing liquid from the basic lignin suspension with a first water solution to provide dirty cake lignin;

(c) comminuting the dirty cake lignin with a comminuting acidic material to provide an acidic lignin suspension having a pH between about 1.5 and about 6.0, wherein the comminuting acidic material is a source of ions and the acidic lignin suspension has an ion concentration between about 0.5 and about 6.0 M; and

(d) precipitating the acidic lignin suspension to provide lignin solids.

In another aspect, a method of separating lignin from black liquor is provided. In one embodiment, the method includes the steps of:

(a) adding a source of ions to a black liquor stream to provide ion-rich black liquor having an ion concentration between about 1.5 and about 7.0 M;

(b) adjusting the pH of the ion-rich black liquor to between about 1.5 and about 6.0 to provide an acidic lignin suspension; and

(c) precipitating the acidic lignin suspension to provide lignin solids.

In another aspect, a method of separating lignin from black liquor is provided. In one embodiment, the method includes the steps of:

(a) adjusting the pH of the black liquor to between about 8.5 and about 10.0 to provide a basic lignin suspension;

(b) separating lignin from the basic lignin suspension to provide dirty cake lignin;

(c) comminuting the dirty cake lignin with a comminuting acidic material to provide an acidic lignin suspension having a pH between about 1.5 and about 6.0, wherein the comminuting acidic material is a source of ions and the acidic lignin suspension has an ion concentration between about 0.5 and about 6.0 M; and

(d) precipitating the acidic lignin suspension to provide lignin solids.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 diagrammatically illustrates a representative process (“FLiP1/2”) for isolating lignin from pulp mill black liquor in accordance with the disclosed embodiments;

FIG. 2 diagrammatically illustrates a representative process (“FLiP3”) for isolating lignin from pulp mill black liquor in accordance with the disclosed embodiments;

FIG. 3 diagrammatically illustrates a representative process (“FLiP4”) for isolating lignin from pulp mill black liquor in accordance with the disclosed embodiments;

FIG. 4 diagrammatically illustrates a representative process (“FLiP5”) for isolating lignin from a pulp mill black liquor in accordance with the disclosed embodiments; and

FIG. 5 diagrammatically illustrates a representative process (“FLiP6”) for isolating lignin from pulp mill black liquor in accordance with the disclosed embodiments.

### DETAILED DESCRIPTION

A process of separating lignin from black liquor from a pulp mill by adjusting the pH of the black liquor is provided. Various additional steps can be used to further process the separated lignin, including washing, drying, and/or comminuting. In certain embodiments, solvents and byproducts are recycled so as to reduce waste and maintain chemical balance within a commercial lignin production facility. In certain embodiments, ions are added to the black liquor (or subsequent intermediate) to facilitate and modify the process of separating lignin from the black liquor.

In the pulping process there is a balance between the wood or other raw material supplied to the pulping process and the chemicals used to remove the lignin and hemicelluloses from the cellulose in the raw material. Maintaining this balance is important. The soda process uses sodium hydroxide as the cooking chemical in the cooking liquor. The sulfate process uses sodium hydroxide and sodium sulfide as the cooking chemicals in the cooking liquor. It can be seen that the two chemicals that are found in these processes are sodium and sulfur and it is necessary to keep these two chemicals in balance in the pulping process. In one embodiment, the present process is directed to a method of removing lignin from the spent pulping liquor, the black liquor, while keeping the chemical balance in the pulping process. In another embodiment, it is also directed to using pulp mill make-up chemicals in a different way to reduce mill process costs. In yet another embodiment it is directed to reducing the amount of chemicals sent to waste streams or landfill.

In one embodiment, only chemicals used in the pulping process, sodium and sulfur, are used to treat the spent liquor and remove the lignin. These chemicals may then be returned to the pulping process or removed, depending on the amount of chemicals used.

A by-product of the kraft pulping process is sodium sulfate. In the kraft pulping process the pulping or cooking chemicals are recycled by burning the black liquor in a recovery boiler. In this process sodium sulfate is formed as a particulate which is carried from the boiler in the flue gases. A precipitator in the recovery boiler stack catches this particulate material as precipitator ash.

Another by-product is acidic salt cake, sulfuric acid and sodium sulfate, which is formed during the manufacture or generation of chlorine dioxide (ClO₂) bleach chemical. Acidic salt cake is currently used to make up sodium and sulfur lost during the cooking or pulping process and in the recovery boiler. Sulfuric acid reduces pH and sodium sulfate increases ionic strength, both of which promote lignin precipitation and particle formation. Acidic salt cake solution has a pH of −0.15 to 0.15, depending on concentration. Sodium hydroxide is also used to make-up sodium lost during the process. In certain disclosed embodiments, the acidic salt cake can be used first to adjust the pH of the black liquor to precipitate lignin from the black liquor and the sodium hydroxide can be used to adjust the pH of the liquor returning to the pulp mill and then the chemicals can be used to replace sodium and sulfur lost in the pulping and recovery process. This can also reduce the need for fresh chemicals and the cost of fresh chemicals in the process.

In another embodiment other chemicals are used to treat the black liquor and remove the lignin. These other chemicals may need to be removed before returning the material to the pulping process.

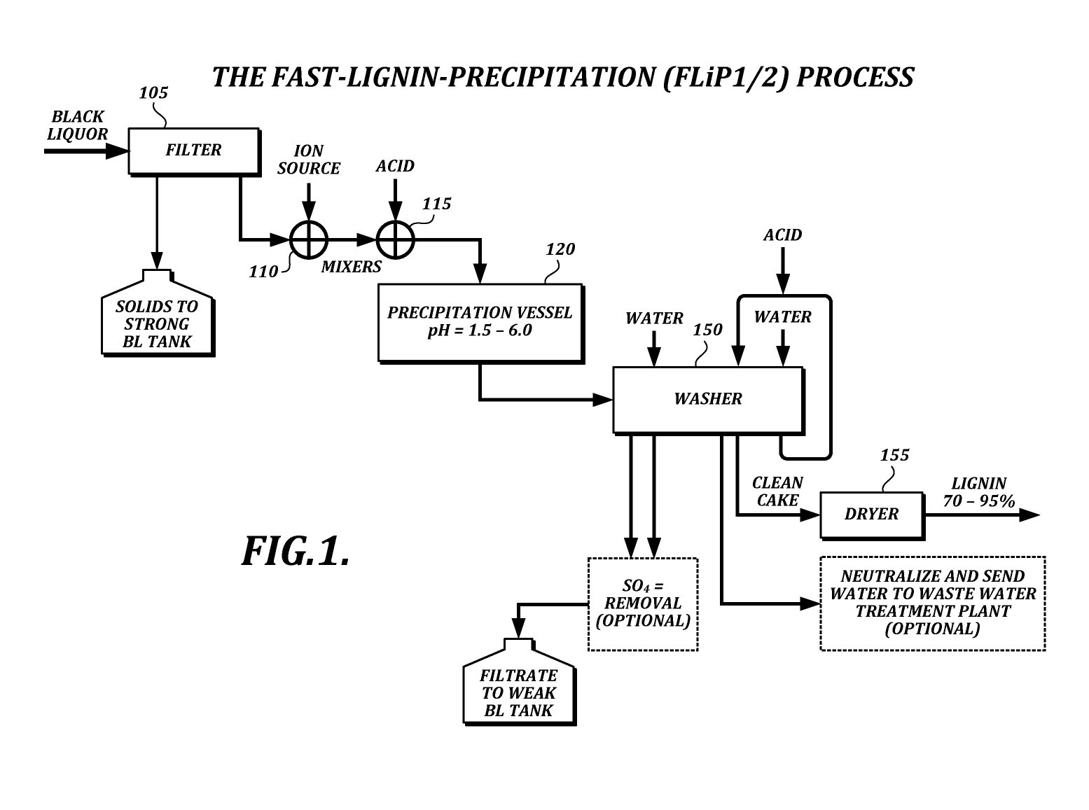

The various aspects and embodiments disclosed herein are referred to as a “fast lignin precipitation process” or “FLiP.” Six example FLiP versions will be discussed specifically herein, and are illustrated in FIGS. 1-5, although it will be appreciated that many more variations of the FLiP process are contemplated through modifications to the specifically described FLiP processes.

FLiP1/2

The process referred to as FLiP1/2 is illustrated in FIG. 1 and will now be described in detail. FLiP1/2 is a single-vessel acidic precipitation process for generating lignin from black liquor. Exemplary results of lignin production using the FLiP1/2 process are described in further detail in Example 1.

In one aspect, a method of separating lignin from black liquor is provided. In one embodiment, the method includes the steps of:

(a) adding a source of ions to a black liquor stream to provide ion-rich black liquor having an ion concentration between about 1.5 and about 7.0 M;

(b) adjusting the pH of the ion-rich black liquor to between about 1.5 and about 6.0 to provide an acidic lignin suspension; and

(c) precipitating the acidic lignin suspension to provide lignin solids.

Referring to FIG. 1, the FLiP1/2 process begins by providing black liquor from a pulp mill to a filter 105 to remove extraneous material such as fibers, char, sand, and other inorganic solids.

Regarding the source of the black liquor, wood chips are cooked in the cooking liquor under heat and pressure in a digester. After cooking, the chips and black liquor are blown from the digester by passing the chips and black liquor from the digester pressure to a lower pressure. In this process, the chips are fiberized into cellulose fibers. The cellulose and black liquor then pass to a brown stock washer in which the black liquor is washed from the cellulose. The cellulose then may go to a bleaching stage and the black liquor goes to weak black liquor storage. The black liquor then passes through a series of evaporators to concentrate the black liquor and reduce the amount of water in it prior to sending it to the recovery boiler. The concentrated black liquor is stored in concentrated black liquor tanks before being sent to the recovery boiler.

The black liquor provided to the present lignin recovery process can come from the weak black liquor tanks or the concentrated black liquor tanks. It can be conditioned by heating or cooling and diluting within the range of operating conditions. The black liquor is filtered through a filter with pore size in micrometer, to remove any solids. The black liquor has a pH of around 13 prior to treatment by the disclosed process.

The filter 105 separates solids that are then removed from the process. For example, the solids can be moved to the strong black liquor tank for further processing.

The liquid passing through the filter 105 proceeds to a mixer 110 in which an ion source is added. The ion source can be a solid or liquid that provides cations and/or anions. The ion source may be added as a new material or can be a recycled material from further processing steps of the provided method. Exemplary ion sources include inorganic salts (e.g., NaCl, Na₂S₂O₃, Na₂SO₄), precipitator ash (comprising, by weight, about 20% Na₂CO₃ and 80% Na₂SO₄), and salt cake solution (e.g., having a solids level of 20%, with the solids having a composition of about 20% H₂SO₄ and about 80% Na₂SO₄).

In function, the ions interact with dissolved lignin molecules to reduce their solubility and promote their precipitation quickly. The ions also interact with precipitated, fine lignin particles to increase aggregation and form stable, granular, large particles. This type of particle has a high filtration rate and is stable during washing with water. With the control of the level of the ions in the system and (optional) comminutor conditions, the lignin particle size can be controlled to achieve a specified purity of lignin with a minimal amount of wash water (which reduces both water waste and allows for a smaller washer to be used).

Added acids also contribute to the overall ion concentration of the black liquor. For example, if carbonic or sulfuric acid added to reduce the pH of the black liquor, these would be converted into CO₃²⁻ and SO₄²⁻, respectively, which would then become part of the ion concentration.

The concentration of ions in the black liquor, after treatment, is between about 1.5 and 7.0 M. This includes ions from the ion source, acidic material, and ions contained within the original black liquor. The maximum amount of ions added is 5.5 M.

Next, the ion-rich black liquor passes into another mixer 115 in which an acidic material is added to the black liquor in order to adjust (e.g., lower) the pH of the black liquor and precipitate lignin from the black liquor. The pH of the acidic black liquor is in the range of 1.5 to 6.0. The switch from basic to acidic conditions results in the precipitation of solid lignin from the black liquor (an “acidic lignin suspension”). FLiP1 is referred to herein as an extremely acidic process (e.g., a precipitation pH range of about 1.5 to about 3.0). FLiP2 refers to a process with a precipitation pH range of about 3.0 to about 6.0. Because these two processes are otherwise the same, they are generally referred to herein at FLiP1/2.

In one embodiment the acidic material is carbon dioxide. In another embodiment the acidic material may is an inorganic or organic acid. In one embodiment the acid is sulfuric acid. In one embodiment the acid is carbonic acid (H₂CO₃). In one embodiment the acid is acetic acid (CH₃COOH). In one embodiment, the acid is formic acid (HCOOH).

The ion source and the acid can be added in a single step, added sequentially with the ion source first and then the acid (as illustrated in FIG. 1), or added sequentially with the acid first and then the ion source.

The acidic lignin suspension is then moved into a precipitation vessel 120 to allow for the precipitation process to run to completion. Specifically, lignin molecules contain a weak acidic functional group (phenolic hydroxyl) that is affected by pH. At a pH above 10, phenolic hydroxyl groups (lignin-OH) are dissociated and converted to a sodium form (lignin-ONa). The sodium form of the phenolic hydroxyl groups are hydrophilic and make the lignin molecules soluble in water. When the pH is reduced to 10 and below, the sodium form of the phenolic hydroxyl groups are converted back to the hydroxyl form (lignin-OH). The hydroxyl form of the phenolic hydroxyl groups are hydrophobic and make the lignin molecules insoluble in water. The pH level that triggers the precipitation is partially dependent on the molecular weight of the lignin molecule. In general, higher molecular weight molecules precipitate at a higher pH.

In one embodiment, the acidic lignin suspension is held in the precipitation vessel 120 for 10 to 120 minutes to allow the precipitated lignin to form large particles. The precipitation vessel 120 can be a horizontal or vertical column with axial mixing mechanism such as blades and recirculation pump. The vertical column can be upflow or downflow. The precipitation vessel 120 can also be a tank with a mixing mechanism such as stirring blade and/or recirculation pump.

In one embodiment, the temperature in the precipitation vessel 120 is maintained at 50° C. to 85° C. This range is below the decomposition temperature of lignin, which is about 120° C., and below the boiling point of water, in order to allow the lignin to form larger particles.

In certain embodiments, sodium sulfate is contained within the acidic lignin suspension (e.g., if it was added as the source of ions). The acidic lignin suspension may contain up to 20% by weight sodium sulfate. The amount of precipitation solids in the acidic lignin suspension will depend on the amount of water in the acidic lignin suspension and the treating liquids. The “total solids” includes precipitated and dissolved lignin, dissolved carbohydrates and other organics, as well as dissolved inorganics. In the provided embodiment, the total solids are typically from 10 to 60% of the total weight of the acidic lignin suspension in the precipitation vessel after precipitation has run to completion (i.e., when precipitation has ceased).

In one embodiment, the acidic lignin suspension is agitated in the precipitation vessel 120 to cause the small particles of lignin to combine into larger particles. The agitation speed is, for example, from 100 to 300 revolutions per minute (rpm) to allow the agglomeration to occur.

Next, the precipitated lignin from the precipitation vessel 120 is moved to a washer 150. The lignin is then washed to remove the dissolved organics and inorganics from the lignin. The washing liquids temperature is in the range of 55° C. to 75° C., again below the dissolution temperature of the lignin, 120° C., and the boiling point of water.

The washer 150 can be any type of washing equipment known to those of skill in the art, such as belt filter, a drum filter, a press filter, or a centrifuge.

In one embodiment, in the washer 150, the bulk of the filtrate is first removed by a first stage filtration. This is prior to the first washing stage. The first stage filtration is followed by washing the lignin cake.

In one embodiment, a multi-stage washing system is used. As an example, a three-stage washing system can be used. The first wash stage removes most of the dissolved organics and inorganics. Mill water, deionized water, and/or recycled waste water, for example, may be used in the first wash stage. The pH of the first wash stage is typically about 2 to 7. In one embodiment of the multi-stage washer, the remaining stages are separate. In another embodiment, the remaining stages are a recycle cycle in which the filtrate from the third wash stage is used as the wash liquid for the second wash stage. The second wash liquid has a pH of 1.5 to 2. Acid (e.g., sulfuric acid) can be added to the second wash liquid to reduce the pH to 1.5 to 2. The purpose of the acid pH is to dissociate Na and other metal elements from lignin for removing. Water is used in the third wash stage. The pH of the third wash stage is typically 6 to 7. After the washer 150, the lignin is considered “clean cake” lignin. The clean cake lignin has 40 to 60% solids by weight.

Next, the clean cake lignin goes to a dryer 155 in which it is dried to a solids content of 70 to 95% by weight. The dryer 155 can be any type of drying equipment such as belt, rotary drum, and spray dryer. The drying can be direct or indirect. The drying heat can be from steam, heated air, combustion of natural gas or oil, electrical element, and IR/microwave element. The produced lignin can have a yield of 80-95%, a high purity (ash content as low as 0.05-0.25%, sodium content as low as 30-250 ppm, and sulfur content as low as 2.0-2.5%), mid to high polydispersity (4.0-5.5 Mw/Mn), and insignificant smell.

Optionally, the filtrate from the washer 150 is sent to waste water treatment. If needed sodium hydroxide is added to the filtrate or filtrates to raise the pH of the filtrate to a pH of 7 to 8.

In one optional embodiment, the filtrate from the washer 150 (particularly the pre-washing filtrate and the filtrate from the first washing stage) is sent to a sulfate removal system. Removing sulfate helps to maintain the sulfur balance of the pulp mill.

FLiP3

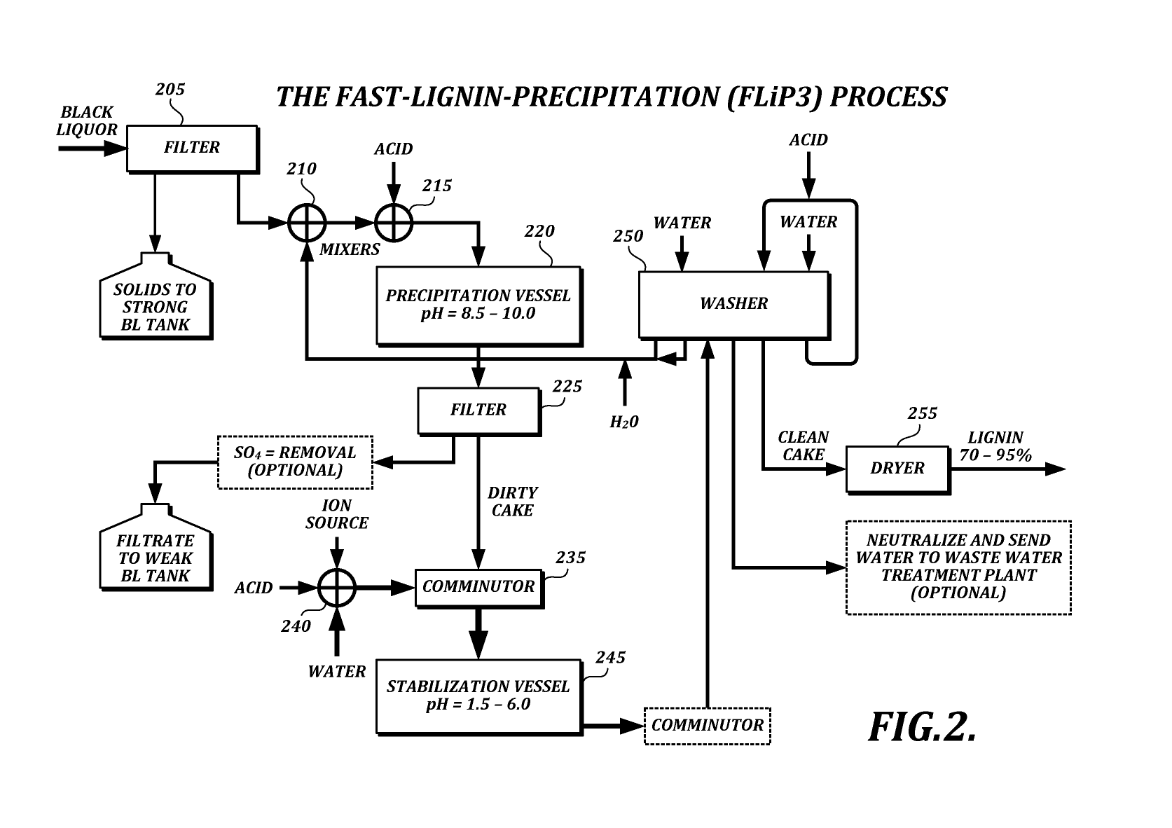

The process referred to as FLiP3 is illustrated in FIG. 2 and will now be described in detail. FLiP3 is a double-vessel precipitation process for generating lignin from black liquor. Exemplary results of lignin production using the FLiP3 process are described in further detail in Example 2.

Certain aspects of FLiP3 are similar to FLiP1/2, as described above.

In another aspect, a method of separating lignin from black liquor is provided. In one embodiment, the method includes the steps of:

(a) adjusting the pH of the black liquor to between about 8.5 and about 10.0 to provide a basic lignin suspension;

(b) separating lignin from the basic lignin suspension to provide dirty cake lignin;

(c) comminuting the dirty cake lignin with a comminuting acidic material to provide an acidic lignin suspension having a pH between about 1.5 and about 6.0, wherein the comminuting acidic material is a source of ions and the acidic lignin suspension has an ion concentration between about 0.5 and about 6.0 M; and

(d) precipitating the acidic lignin suspension to provide lignin solids.

Referring to FIG. 2, the FLiP3 process begins by providing black liquor from a pulp mill to a filter 205 to remove extraneous material such as fibers, char, sand, and other inorganic solids. This step is similar to FLiP1/2.

The liquid passing through the filter 205 proceeds to be pH-adjusted by a first mixer 210 in which a first acidic material is added, and another mixer 115 in which a second acidic material is added to the black liquor in order to adjust (e.g., lower) the pH of the black liquor and precipitate lignin from the black liquor. The pH of the black liquor is in the range of 8.5 to 10.0. The reduction of pH from the original black liquor results in the precipitation of solid lignin from the black liquor (a “basic lignin suspension”).

At least one of the first acidic material and the second acidic material is recycled filtrate provided by the washer 250, as will be described in more detail below. The other acidic material is an acidic material as described with regard to FLiP1/2. However, in one embodiment, the recycled filtrate from the washer is sufficient to adjust the pH of the black liquor to the desired range and so no second acidic material is required.

The basic lignin suspension is then moved into a precipitation vessel 220 to allow for the precipitation process to run to completion.

In one embodiment, the basic lignin suspension is held in the precipitation vessel 220 for 10 to 120 minutes to allow the precipitated lignin to form large particles. The precipitation vessel 220 can be a horizontal or vertical column with axial mixing mechanism such as blades and recirculation pump. The vertical column can be upflow or downflow. The precipitation vessel 220 can also be a tank with a mixing mechanism such as stirring blade and/or recirculation pump.

In one embodiment, the temperature in the precipitation vessel 220 is maintained at 50° C. to 85° C. This range is below the decomposition temperature of lignin, which is about 120° C., and below the boiling point of water, in order to allow the lignin to form larger particles.

In certain embodiments, sodium sulfate is contained within the basic lignin suspension. The basic lignin suspension may contain up to 20% by weight sodium sulfate. The amount of precipitation solids in the acidic lignin suspension will depend on the amount of water in the basic lignin suspension and the treating liquids. The total solids are typically from 10 to 60% of the total weight of the basic lignin suspension in the precipitation vessel after precipitation has run to completion (i.e., when precipitation has ceased).

In one embodiment, the basic lignin suspension is agitated in the precipitation vessel 220 to cause the small particles of lignin to combine into larger particles. The agitation speed is, for example, from 100 to 300 revolutions per minute (rpm) to allow the agglomeration to occur.

The contents of the precipitation vessel 220 are then passed through a filter 225 in order to separate solids (“dirty cake” lignin) from liquids (the “filtrate”).

In one embodiment, the filtrate is sent to the weak black liquor tank. In another embodiment, the filtrate is sent to a sulfate removal system to remove part of the sulfate for maintaining the sulfur balance of the pulp mill. The precipitation chemical can be CaO or Ca(OH)₂. The solids will be mainly CaSO₄ and CaCO₃, which can be sent to a landfill.

The dirty cake lignin from the filter 225 is sent to a comminutor 235. In this step, the dirty cake is completely dispersed in solution. The comminutor 235 can be a grinder, refiner, or high shear mixer.

The dirty cake is mixed in the comminutor 235 with a mixture 240 that includes an acid and an ion source (similar to that described with regard to FLiP1/2). The mixture 240 may include one or more of recycled washer 250 filtrate, the ion source, and an inorganic or organic acid to lower the pH of the comminuted material to 1.5 to 6.0. Representative acids useful in this step are similar to those described above with reference to FLiP1/2.

By delaying the addition of ions until the comminutor 235, as opposed to adding them directly to the black liquor, the ions are used first in the stabilization stage and then in the precipitation stage through mixing the filtrate from the acidic lignin suspension with the black liquor.

In the comminutor 235, the pH is adjusted to between 1.5 and 6.0 in order to facilitate further lignin precipitation, thereby forming an “acidic lignin suspension.”

The acidic lignin suspension has an ion concentration between about 0.5 and 6.0 M. The dirty cake provides a small amount of the ions in the acidic lignin suspension, and the remaining ions are provided by the ion source. The maximum amount of ions added is 5.5 M.

The acidic lignin suspension is moved to a stabilization vessel 245 where the lignin particles are stabilized for the following washing. The stabilization vessel 245 can be a horizontal or vertical column with axial mixing mechanism such as blades and recirculation pump. The vertical column can be upflow or downflow. The stabilization vessel 245 can also be a tank with a mixing mechanism such as stirring blade and recirculation pump.

The acidic lignin suspension remains in the stabilization vessel 245 for 10 to 120 minutes at a temperature of 50 to 85° C. The amount of sodium sulfate in the basic lignin suspension can be up to 20% of its weight. The stabilization vessel 245 is also agitated to disperse the lignin particles in the acidic solution for stabilization and to allow the dissolved organic and inorganic ions diffusing from inside the lignin particles to the solution. The agitation speed is from 100 to 300 rpm.

The precipitated lignin solids can optionally be comminuted (e.g., to control particle size) again prior to being moved to the washer 250.

In the washer 250, the washing liquids temperature is in the range of 55° C. to 75° C., again below the dissolution temperature of the lignin, 120° C. and the boiling point of water.

The washer 250 can be any type of washing equipment such as belt filter, a drum filter, a press filter, or a centrifuge.

In the washer 250, most of the filtrate is first removed by a first stage filtration. This is prior to the first washing stage. The first stage filtration is followed by washing the lignin cake. In one embodiment, the filtrate from the first stage filtration is returned to the mixer 210 in order to adjust the pH of the black liquor. The filtrate has a pH of about 1.5 to 6.0.

In one embodiment, a multi-stage washing system is used. As an example, a three-stage washing system can be used. The first wash stage removes most of the dissolved organics and inorganics. Mill water, deionized water, and/or recycled waste water, for example, may be used in the first wash stage. The pH of the first wash stage is typically about 2 to 7. In one embodiment of the multi-stage washer the remaining stages are separate. In another embodiment the remaining stages are a recycle cycle in which the filtrate from the third wash stage is used as the wash liquid for the second wash stage. The second wash liquid has a pH of 1.5 to 2. Acid (e.g., sulfuric acid) can be added to the second wash liquid to reduce the pH to 1.5 to 2. The purpose of the acid pH is to dissociate Na and other metal elements from lignin for removing. Water is used in the third wash stage. The pH of the third wash stage is typically 6 to 7.

In one embodiment, the filtrate from the first wash stage is returned to the mixer 210 in order to adjust the pH of the black liquor. It has a pH of 1.5 to 6.0. This acidic wash filtrate may be used in combination with, or instead of, the filtrate collected from the washer 250 prior to the beginning of the washing processes.

After the washer 250, the lignin is considered “clean cake” lignin. The clean cake lignin has 40 to 60% solids by weight.

Next, the clean cake lignin then goes to a dryer 255 in which it is dried to a solids content of 70 to 95% by weight. The dryer 255 can be any type of drying equipment such as belt, rotary drum, and spray dryer. The drying can be direct or indirect. The drying heat can be from steam, heated air, combustion of natural gas or oil, electrical element, and IR/microwave element. The produced lignin can have a yield of 70-75%, a high purity (ash content as low as 0.05-0.25%, sodium content as low as 30-250 ppm, and sulfur content as low as 2.0-2.5%), low to mid polydispersity (3.5-4.0 Mw/Mn), and insignificant smell.

Optionally, the filtrate from the washer 250 is sent to waste water treatment. If needed sodium hydroxide is added to the filtrate or filtrates to raise the pH of the filtrate to a pH of 7 to 8.

FLiP4

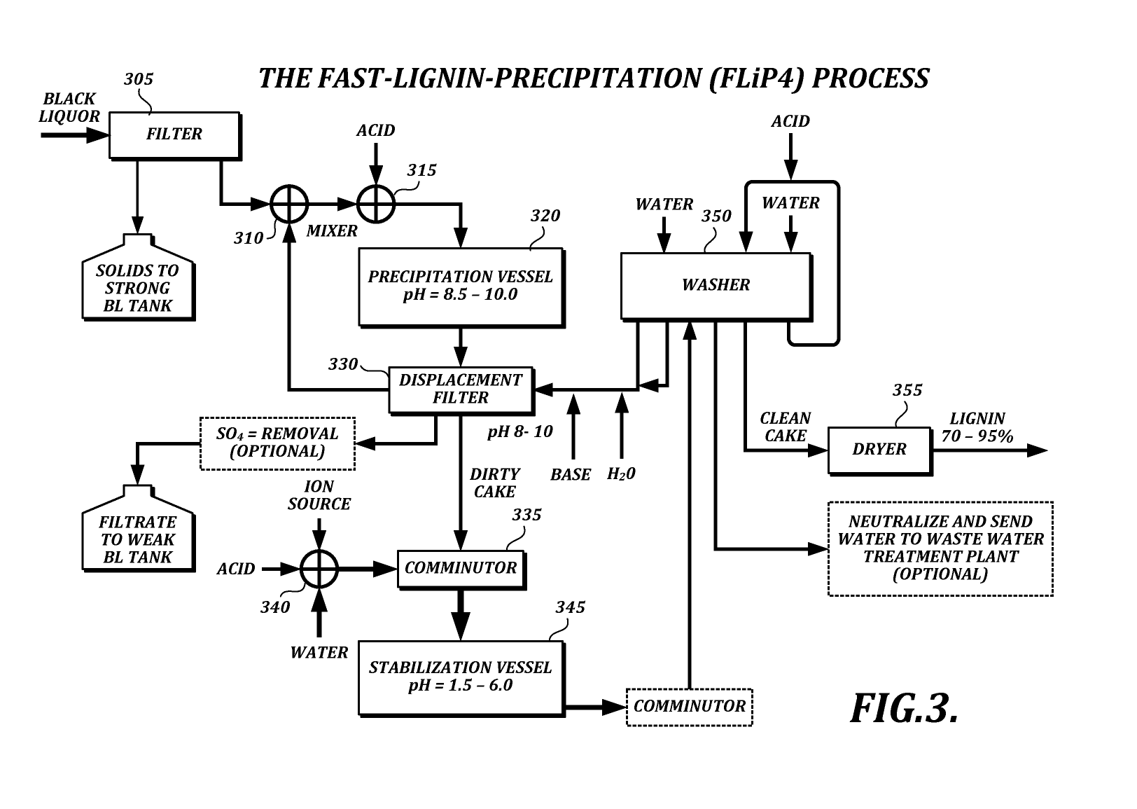

The process referred to as FLiP4 is illustrated in FIG. 3 and will now be described in detail. FLiP4 is a double-vessel precipitation process for generating lignin from black liquor. Exemplary results of lignin production using the FLiP4 process are described in further detail in Example 3.

Certain aspects of FLiP4 are similar to FLiP1/2 and FLiP3, as described above.

In another aspect, a method of separating lignin from black liquor is provided. In one embodiment, the method includes the steps of:

(a) adjusting the pH of the black liquor to between about 8.5 and about 10.0 to provide a basic lignin suspension;

(b) displacing liquid from the basic lignin suspension with a first water solution to provide dirty cake lignin;

(c) comminuting the dirty cake lignin with a comminuting acidic material to provide an acidic lignin suspension having a pH between about 1.5 and about 6.0, wherein the comminuting acidic material is a source of ions and the acidic lignin suspension has an ion concentration between about 0.5 and about 6.0 M; and

(d) precipitating the acidic lignin suspension to provide lignin solids.

One difference between FLiP4 and FLiP3 is the replacement of the filter 225 with a displacement filter 330. As used herein, the term “displacement filter” refers to a special filter that allows filtering the lignin suspension to remove most of the filtrate and then using a small amount of wash liquor (i.e., filtrate from the washer 350) to displace the residual filtrate in the lignin solids. Specifically, the wash liquor is to mainly displace the filtrate outside the lignin particles quickly. The key of the operation is the short retention time of lignin solids in the filter. The equipment has to be able to force the wash liquor into the solids cake quickly by pressure, vacuum, and mechanical press. The displacement filter has more, but smaller, wash liquor spray nozzles, compared to a regular filter or washer, to assure uniform displacement.

In FLiP4, the displacement filter 330 is used to filter the basic lignin suspension from the precipitation vessel 320 to provide dirty cake to the comminutor 335. Additionally, if filtrate from the washer 350 is used to adjust the pH of the black liquor at mixer 310, the filtrate is passed through the displacement filter 330.

Referring to FIG. 3, the FLiP4 process begins by providing black liquor from a pulp mill to a filter 305 to remove extraneous material such as fibers, char, sand, and other inorganic solids. This step is similar to FLiP1/2 and 3.

The liquid passing through the filter 305 proceeds to be pH adjusted by a first mixer 310 in which an alkaline material is added to increase ions content in the black liquor and another mixer 315 in which an acidic material is added to the black liquor in order to adjust (e.g., lower) the pH of the black liquor and precipitate lignin from the black liquor. The pH of the black liquor is in the range of 8.5 to 10.0. The reduction of pH from the original black liquor results in the precipitation of solid lignin from the black liquor (a “basic lignin suspension”).

The alkaline material has about the same pH as the black liquor. Typically, the alkaline material has a pH of about 8.5 to 10.0.

In one embodiment, the alkaline material is the mixture of the recycled filtrate provided by the displacement filter 330 and a base solution, as will be described in more detail below. In a further embodiment, the filtrate from the displacement filter 330 results from a washing liquid that is partially filtrate from a washer 350. In such an embodiment, the filtrate from the washer is acidic and is adjusted to a pH of about 8.5 to 10.0 prior to use in the displacement filter 330. This pH adjustment is accomplished by adding base (e.g., NaOH) and, if necessary, water.

The acidic material is an acidic material as described with regard to FLiP1/2.

After pH adjustment, the basic lignin suspension is then moved into a precipitation vessel 320 to allow for the precipitation process to run to completion.

In one embodiment, the basic lignin suspension is held in the precipitation vessel 320 for 10 to 120 minutes to allow the precipitated lignin to form large particles. The precipitation vessel 320 can be a horizontal or vertical column with axial mixing mechanism such as blades and recirculation pump. The vertical column can be upflow or downflow. The precipitation vessel 320 can also be a tank with a mixing mechanism such as stirring blade and/or recirculation pump.

In one embodiment, the temperature in the precipitation vessel 320 is maintained at 50° C. to 85° C. This range is below the decomposition temperature of lignin, which is about 120° C., and below the boiling point of water, in order to allow the lignin to form larger particles.

In certain embodiments, sodium sulfate is contained within the basic lignin suspension. The basic lignin suspension may contain up to 20% by weight sodium sulfate. The amount of precipitation solids in the acidic lignin suspension will depend on the amount of water in the basic lignin suspension and the treating liquids. The total solids are typically from 10 to 60% of the total weight of the basic lignin suspension in the precipitation vessel 320 after precipitation has run to completion (i.e., when precipitation has ceased).

In one embodiment, the basic lignin suspension is agitated in the precipitation vessel 320 to cause the small particles of lignin to combine into larger particles. The agitation speed is, for example, from 100 to 300 revolutions per minute (rpm) to allow the agglomeration to occur.

The contents of the precipitation vessel 320 are then passed through a displacement filter 330 in order to separate solids (“dirty cake” lignin) from liquids (the “filtrate”).

In one embodiment, the filtrate is sent to the mixer 310, as described above. In another embodiment, the filtrate is sent to a sulfate removal system to remove part of the sulfate for maintaining the sulfur balance of the pulp mill. The precipitation chemical can be CaO or Ca(OH)₂. The solids will be mainly CaSO₄ and CaCO₃, which can be sent to a landfill.

The dirty cake lignin from the displacement filter 330 is sent to a comminutor 335. In this step, the dirty cake is completely dispersed in solution. The comminutor 335 can be a grinder, refiner, or high shear mixer.

The dirty cake is mixed in the comminutor 335 with a mixture 340 that includes an acid and an ion source. The mixture 340 may include one or more of recycled washer 350 filtrate, sodium sulfate, precipitator ash or salt cake solution, and an inorganic or organic acid to lower the pH of the comminuted material to 1.5 to 6.0. Representative ion sources and acids useful in this step are similar to those described above with reference to FLiP1/2.

In the comminutor 335, the pH is adjusted to between 1.5 and 6.0 in order to facilitate further lignin precipitation, thereby forming an “acidic lignin suspension.”

The acidic lignin suspension has an ion concentration between about 0.5 and 6.0 M. The dirty cake provides a small amount of the ions in the acidic lignin suspension, and the remaining ions are provided by the ion source. The maximum amount of ions added is 5.5 M.

The acidic lignin suspension is moved to a stabilization vessel 345 where the lignin particles are stabilized for the following washing. The stabilization vessel 345 can be a horizontal or vertical column with axial mixing mechanism such as blades and recirculation pump. The vertical column can be upflow or downflow. The stabilization vessel 345 can also be a tank with a mixing mechanism such as stirring blade and recirculation pump.

The acidic lignin suspension remains in the stabilization vessel 345 for 10 to 120 minutes at a temperature of 50 to 85° C. The amount of sodium sulfate in the basic lignin suspension can be up to 20% of its weight. The stabilization vessel 345 is also agitated to disperse the lignin particles in the acidic solution for stabilization and to allow the dissolved organics and inorganic ions diffusing from inside the lignin particles to the solution. The agitation speed is from 100 to 300 rpm.

The precipitated lignin solids can optionally be comminuted (e.g., to control particle size) again prior to being moved to the washer 350.

In the washer 350, the washing liquids temperature is in the range of 55° C. to 75° C., again below the dissolution temperature of the lignin, 120° C. and the boiling point of water.

The washer 350 can be any type of washing equipment such as belt filter, a drum filter, a press filter, or a centrifuge.

In the washer 350, most of the filtrate is first removed by a first stage filtration. This is prior to the first washing stage. The first stage filtration is followed by washing the lignin cake. In one embodiment, the filtrate from the first stage filtration is returned to the displacement filter 330 in order to facilitate separation of liquids from solids in the basic lignin suspension from the precipitation vessel 320. The filtrate initially has a pH of about 1.5 to 6.0 but can be adjusted to the range of 8.5 to 10 in order to provide a relatively neutral pH liquid for the displacement filter 330.

In one embodiment, a multi-stage washing system is used. As an example, a three-stage washing system can be used. The first wash stage removes most of the dissolved organics and inorganics. Mill water, deionized water, and/or recycled waste water, for example, may be used in the first wash stage. The pH of the first wash stage is typically about 2 to 7. In one embodiment of the multi-stage washer the remaining stages are separate. In another embodiment the remaining stages are a recycle cycle in which the filtrate from the third wash stage is used as the wash liquid for the second wash stage. The second wash liquid has a pH of 1.5 to 2. Acid (e.g., sulfuric acid) can be added to the second wash liquid to reduce the pH to 1.5 to 2. The purpose of the acid pH is to dissociate Na and other metal elements from lignin for removing. Water is used in the third wash stage. The pH of the third wash stage is typically 6 to 7.

After the washer 350, the lignin is considered “clean cake” lignin. The clean cake lignin has 40 to 60% solids by weight.

Next, the clean cake lignin then goes to a dryer 355 in which it is dried to a solids content of 70 to 95% by weight. The dryer 355 can be any type of drying equipment such as belt, rotary drum, and spray dryer. The drying can be direct or indirect. The drying heat can be from steam, heated air, combustion of natural gas or oil, electrical element, and IR/microwave element. The produced lignin can have a yield of 70-75%, a high purity (ash content as low as 0.05-0.25%, sodium content as low as 30-250 ppm, and sulfur content as low as 2.0-2.5%), low polydispersity (3.0-3.5 Mw/Mn), and insignificant smell.

Optionally, the filtrate from the washer 350 is sent to waste water treatment. If needed sodium hydroxide is added to the filtrate or filtrates to raise the pH of the filtrate to a pH of 7 to 8.

FLiP6

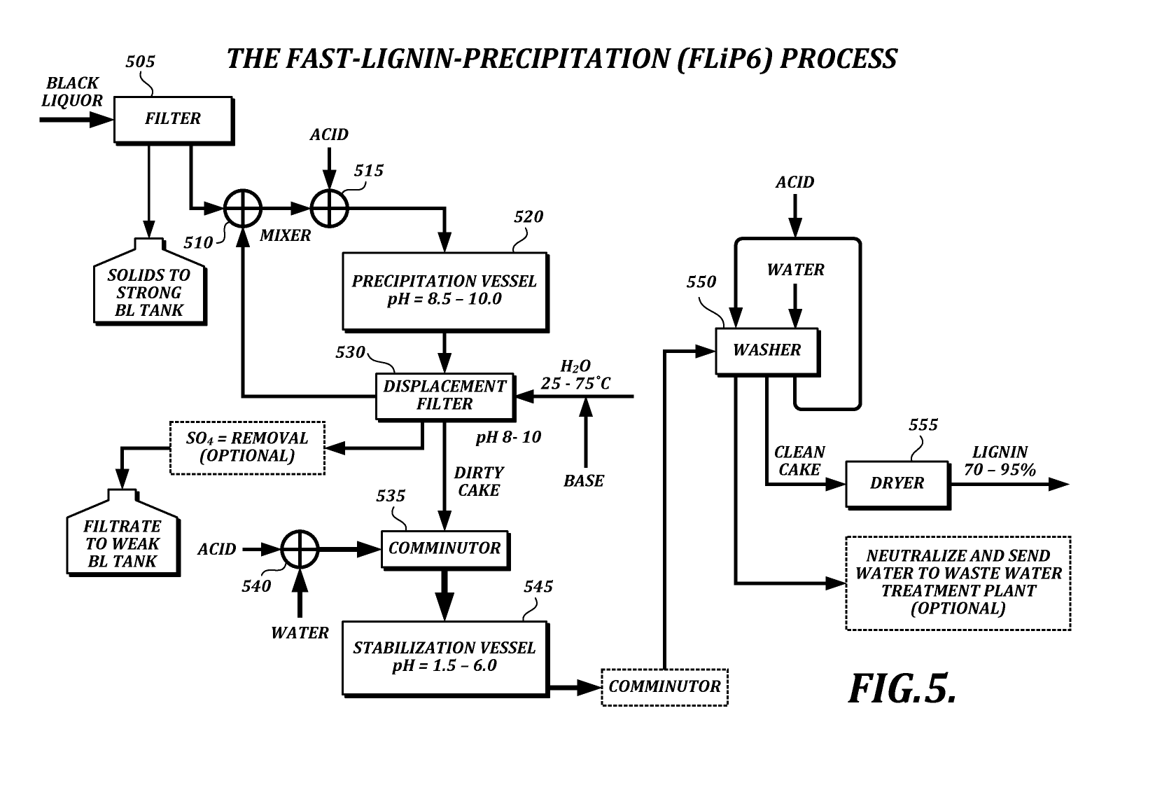

The process referred to as FLiP6 is illustrated in FIG. 5 and will now be described in detail. FLiP6 is a double-vessel precipitation process for generating lignin from black liquor. Exemplary results of lignin production using the FLiP6 (and FLiP5) process are described in further detail in Example 4.

Certain aspects of FLiP6 are similar to FLiP1/2, 3, and 4, as described above. In another aspect, a method of separating lignin from black liquor is provided. In one embodiment, the method includes the steps of:

(a) adjusting the pH of the black liquor to between about 8.5 and about 10.0 to provide a basic lignin suspension;

(b) displacing liquid from the basic lignin suspension with a first water solution to provide dirty cake lignin;

(c) comminuting the dirty cake lignin with a comminuting acidic material to provide an acidic lignin suspension having a pH between about 1.5 and about 6.0 and an ion concentration between about 0.1 and about 0.5 M; and

(d) precipitating the acidic lignin suspension to provide lignin solids.

FLiP6 is particularly similar to FLiP4, but differs in several aspects. First, no ion source is added at any point during the FLiP6 process (excluding ions present from the black liquor and ions from added acidic material). Without additional ions added, the lignin precipitates slower and forms small, non-granular particles. A second difference between FLiP6 and FLiP4 is that the displacement filter 530 is not provided filtrate from the washer 550. Instead, non-recycled water is used in the displacement filter 530.

Referring to FIG. 5, the FLiP6 process begins by providing black liquor from a pulp mill to a filter 505 to remove extraneous material such as fibers, char, sand, and other inorganic solids. This step is similar to FLiP1/2, 3, and 4.

The liquid passing through the filter 505 proceeds to be pH-adjusted by a first mixer 510 in which an alkaline material is added and another mixer 515 in which an acidic material is added to the black liquor in order to adjust (e.g., lower) the pH of the black liquor and precipitate lignin from the black liquor. The pH of the black liquor is in the range of 8.5 to 10.0. The reduction of pH from the original black liquor results in the precipitation of solid lignin from the black liquor (a “basic lignin suspension”).

The alkaline material has the same pH as the black liquor. Typically, the alkaline material has a pH of about 8.5 to 10.0

In one embodiment, the alkaline material is recycled filtrate provided by the displacement filter 530, as will be described in more detail below.

The acidic material is an acidic material as described with regard to FLiP1/2.

After pH adjustment, the basic lignin suspension is then moved into a precipitation vessel 520 to allow for the precipitation process to run to completion.

In one embodiment, the basic lignin suspension is held in the precipitation vessel 520 for 10 to 120 minutes to allow the precipitated lignin to form large particles. The precipitation vessel 520 can be a horizontal or vertical column with axial mixing mechanism such as blades and recirculation pump. The vertical column can be upflow or downflow. The precipitation vessel 520 can also be a tank with a mixing mechanism such as stirring blade and/or recirculation pump.

In one embodiment, the temperature in the precipitation vessel 520 is maintained at 50° C. to 85° C. This range is below the decomposition temperature of lignin, which is about 120° C., and below the boiling point of water, in order to allow the lignin to form larger particles.

The amount of precipitation solids in the basic lignin suspension will depend on the amount of water in the basic lignin suspension and the treating liquids. The total solids are typically from 10 to 60% of the total weight of the basic lignin suspension in the precipitation vessel after precipitation has run to completion (i.e., when precipitation has ceased).

In one embodiment, the basic lignin suspension is agitated in the precipitation vessel 520 to cause the small particles of lignin to combine into larger particles. The agitation speed is, for example, from 100 to 300 revolutions per minute (rpm) to allow the agglomeration to occur.

The contents of the precipitation vessel 520 are then passed through a displacement filter 530 in order to separate solids (“dirty cake” lignin) from liquids (the “filtrate”).

In one embodiment, the filtrate is sent to the mixer 510, as described above. In another embodiment, the filtrate is sent to a sulfate removal system to remove part of the sulfate for maintaining the sulfur balance of the pulp mill. The precipitation chemical can be CaO or Ca(OH)₂. The solids will be mainly CaSO₄ and CaCO₃, which can be sent to a landfill.

The dirty cake lignin from the displacement filter 530 is sent to a comminutor 535. In this step, the dirty cake is completely dispersed in solution. The comminutor 535 can be a grinder, refiner, or high shear mixer.

The dirty cake is mixed in the comminutor 535 with a mixture 540 that includes an acid and, optionally, water. The mixture 540 may include one or more of recycled washer 550 filtrate and an inorganic or organic acid to lower the pH of the comminuted material to 1.5 to 6.0. Representative acids useful in this step are similar to those described above with reference to FLiP1/2.

In the comminutor 535 the pH is adjusted to between 1.5 and 6.0 in order to facilitate further lignin precipitation, thereby forming an “acidic lignin suspension.”

The acidic lignin suspension has an ion concentration between about 0.5 and 2.0 M, which includes the ions from added acid. The dirty cake and acid provide the ion concentration.

The acidic lignin suspension is moved to a stabilization vessel 545 where the lignin particles are stabilized for the following washing. The stabilization vessel 545 can be a horizontal or vertical column with axial mixing mechanism such as blades and recirculation pump. The vertical column can be upflow or downflow. The stabilization vessel 545 can also be a tank with a mixing mechanism such as stirring blade and recirculation pump.

The acidic lignin suspension remains in the stabilization vessel 545 for 10 to 120 minutes at a temperature of 50 to 85° C. The stabilization vessel 545 is also agitated to disperse the lignin particles in the acidic solution for stabilization and to allow the dissolved hemicelluloses and inorganic ions diffusing from inside the lignin particles to the solution. The agitation speed is from 100 to 300 rpm.

The precipitated lignin solids can optionally be comminuted (e.g., to control particle size) again prior to being moved to the washer 550.

In the washer 550, the washing liquids temperature is in the range of 55° C. to 75° C., again below the dissolution temperature of the lignin, 120° C. and the boiling point of water.

The washer 550 can be any type of washing equipment such as belt filter, a drum filter, a press filter, or a centrifuge.

In one embodiment, a multi-stage washing system is used. As an example, a two-stage washing system can be used. The first wash stage is acidic and the second is neutral (e.g., water). In one embodiment of the multi-stage washer the stages are a recycle cycle in which the filtrate from the second wash stage is used as the wash liquid for the second wash stage. The first wash liquid has a pH of 1.5 to 2. Acid (e.g., sulfuric acid) can be added to the filtrate from the second wash liquid to reduce the pH to 1.5 to 2. The purpose of the acid pH is to dissociate Na and other metal elements from lignin for removing. Water is used in the second wash stage. The pH of the second wash stage is typically 6 to 7.

After the washer 550, the lignin is considered “clean cake” lignin. The clean cake lignin has 40 to 60% solids by weight.

Next, the clean cake lignin then goes to a dryer 555 in which it is dried to a solids content of 70 to 95% by weight. The dryer 555 can be any type of drying equipment such as belt, rotary drum, and spray dryer. The drying can be direct or indirect. The drying heat can be from steam, heated air, combustion of natural gas or oil, electrical element, and IR/microwave element. The produced lignin can have a yield of 70-75%, a high purity (ash content as low as 0.05-0.25%, sodium content as low as 30-250 ppm, and sulfur content as low as 2.0-2.5%), low polydispersity (3.0-3.5 Mw/Mn), and insignificant smell.

Optionally, the filtrate from the washer 550 is sent to waste water treatment. If needed sodium hydroxide is added to the filtrate or filtrates to raise the pH of the filtrate to a pH of 7 to 8.

FLiP5

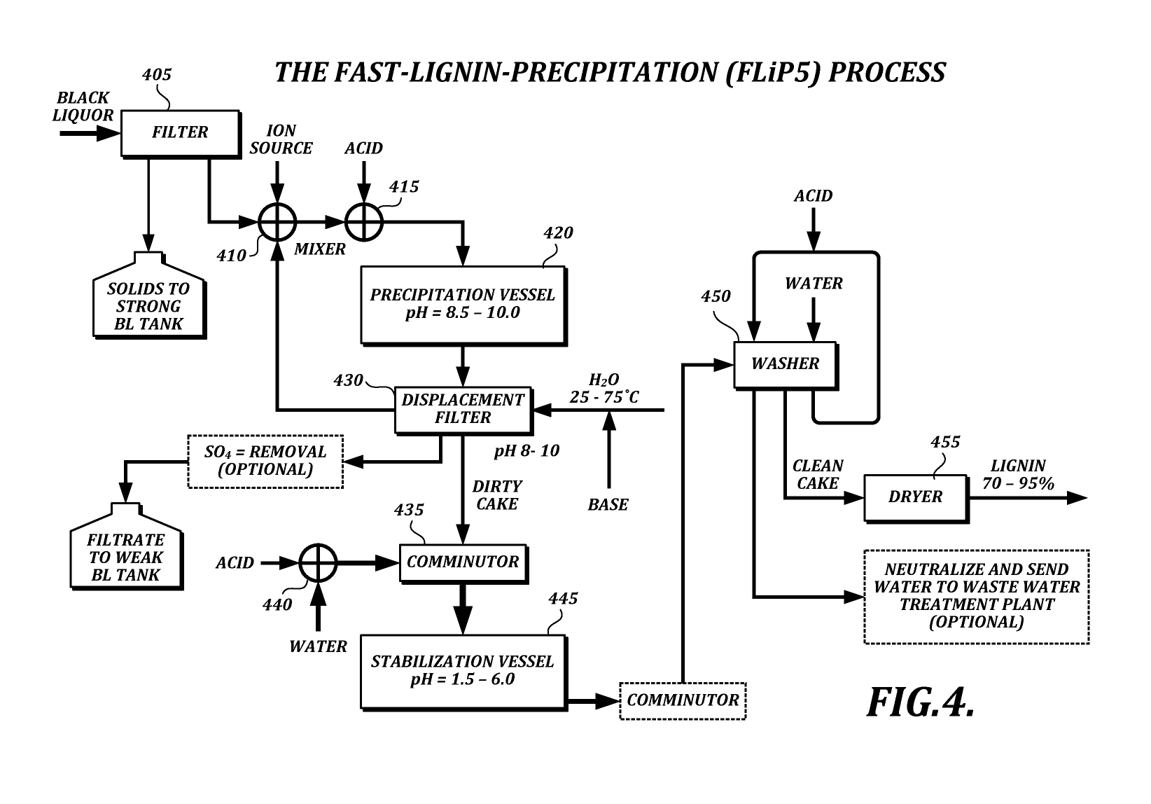

The process referred to as FLiP5 is illustrated in FIG. 4 and will now be described in detail. FLiP5 is a double-vessel precipitation process for generating lignin from black liquor. Exemplary results of lignin production using the FLiP5 (and FLiP6) process are described in further detail in Example 4.

Certain aspects of FLiP5 are similar to FLiP1/2, 3, 4, and 6, as described above.

In one embodiment, the method of FLiP5 further comprises a step of adding a source of ions to the black liquor before the step of adjusting the pH of the black liquor.

The FLiP5 process is similar to the FLiP6 process, with one notable exception: FLiP5 introduces additional ion content into the process in the form of the addition of an ion source to the black liquor at mixer 410. As discussed previously, the addition of ions speeds the precipitation process and results in larger lignin particles.

Referring to FIG. 4, the FLiP5 process begins by providing black liquor from a pulp mill to a filter 405 to remove extraneous material such as fibers, char, sand, and other inorganic solids. This step is similar to FLiP1/2, 3, 4, and 6.

The liquid passing through the filter 405 proceeds to be pH adjusted by a first mixer 410 in which an alkaline material is added. The alkaline material has the same pH as the black liquor. Typically, the alkaline material has a pH of about 8.5 to 10.0. In one embodiment, the alkaline material is recycled filtrate provided by the displacement filter 430, as will be described in more detail below.

In a step similar to FLiP1/2, an ion source is also added at the mixer 410. The concentration of ions in the black liquor, after treatment, is between about 1.5 and 7.0 M. This includes ions from the ion source, acidic material, and ions contained within the original black liquor. The maximum amount of ions added is 5.5 M.

At a second mixer 415, an acidic material is added to the black liquor in order to adjust (e.g., lower) the pH of the black liquor and precipitate lignin from the black liquor. The pH of the basic black liquor is in the range of 8.5 to 10.0. The reduction of pH from the original black liquor results in the precipitation of solid lignin from the black liquor (a “basic lignin suspension”). The acidic material is an acidic material as described with regard to FLiP1/2.

After pH adjustment, the basic lignin suspension is then moved into a precipitation vessel 420 to allow for the precipitation process to run to completion.

In one embodiment, the basic lignin suspension is held in the precipitation vessel 420 for 10 to 120 minutes to allow the precipitated lignin to form large particles. The precipitation vessel 420 can be a horizontal or vertical column with axial mixing mechanism such as blades and recirculation pump. The vertical column can be upflow or downflow. The precipitation vessel 420 can also be a tank with a mixing mechanism such as stirring blade and/or recirculation pump.

In one embodiment, the temperature in the precipitation vessel 420 is maintained at 50° C. to 85° C. This range is below the decomposition temperature of lignin, which is about 120° C., and below the boiling point of water, in order to allow the lignin to form larger particles.

The amount of precipitation solids in the acidic lignin suspension will depend on the amount of water in the basic lignin suspension and the treating liquids. The total solids are typically from 10 to 60% of the total weight of the basic lignin suspension in the precipitation vessel after precipitation has run to completion (i.e., when precipitation has ceased).

In one embodiment, the basic lignin suspension is agitated in the precipitation vessel 420 to cause the small particles of lignin to combine into larger particles. The agitation speed is, for example, from 100 to 300 revolutions per minute (rpm) to allow the agglomeration to occur.

The contents of the precipitation vessel 420 are then passed through a displacement filter 430 in order to separate solids (“dirty cake” lignin) from liquids (the “filtrate”).

In one embodiment, the filtrate is sent to the mixer 410, as described above. In another embodiment, the filtrate is sent to a sulfate removal system to remove part of the sulfate for maintaining the sulfur balance of the pulp mill. The precipitation chemical can be CaO or Ca(OH)₂. The solids will be mainly CaSO₄ and CaCO₃, which can be sent to a landfill.

The dirty cake lignin from the displacement filter 430 is sent to a comminutor 435. In this step, the dirty cake is completely dispersed in solution. The comminutor 435 can be a grinder, refiner, or high shear mixer.

The dirty cake is mixed in the comminutor 435 with a mixture 440 that includes an acid and, optionally, water. The mixture 440 may include one or more of recycled washer 450 filtrate and an inorganic or organic acid to lower the pH of the comminuted material to 1.5 to 6.0. Representative acids useful in this step are similar to those described above with reference to FLiP1/2.

In the comminutor 435 the pH is adjusted to between 1.5 and 6.0 in order to facilitate further lignin precipitation, thereby forming an “acidic lignin suspension.”

The acidic lignin suspension has an ion concentration between about 0.5 and 2.0 M. The dirty cake and acid provide the ion concentration.

The acidic lignin suspension is moved to a stabilization vessel 445 where the lignin particles are stabilized for the following washing. The stabilization vessel 445 can be a horizontal or vertical column with axial mixing mechanism such as blades and recirculation pump. The vertical column can be upflow or downflow. The stabilization vessel 445 can also be a tank with a mixing mechanism such as stirring blade and recirculation pump.

The acidic lignin suspension remains in the stabilization vessel 445 for 10 to 120 minutes at a temperature of 50 to 85° C. The stabilization vessel 445 is also agitated to disperse the lignin particles in the acidic solution for stabilization and to allow the dissolved hemicelluloses and inorganic ions diffusing from inside the lignin particles to the solution. The agitation speed is from 100 to 300 rpm.

The precipitated lignin solids can optionally be comminuted (e.g., to control particle size) again prior to being moved to the washer 450.

In the washer 450, the washing liquids temperature is in the range of 55° C. to 75° C., again below the dissolution temperature of the lignin, 120° C. and the boiling point of water.

The washer 450 can be any type of washing equipment such as belt filter, a drum filter, a press filter, or a centrifuge.

In one embodiment, a multi-stage washing system is used. As an example, a two-stage washing system can be used. The first wash stage is acidic and the second is neutral (e.g., water). In one embodiment of the multi-stage washer the stages are a recycle cycle in which the filtrate from the second wash stage is used as the wash liquid for the second wash stage. The first wash liquid has a pH of 1.5 to 2. Acid (e.g., sulfuric acid) can be added to the filtrate from the second wash liquid to reduce the pH to 1.5 to 2. The purpose of the acid pH is to dissociate Na and other metal elements from lignin for removing. Water is used in the second wash stage. The pH of the second wash stage is typically 6 to 7.

After the washer 450, the lignin is considered “clean cake” lignin. The clean cake lignin has 40 to 60% solids by weight.

Next, the clean cake lignin then goes to a dryer 455 in which it is dried to a solids content of 70 to 95% by weight. The dryer 455 can be any type of drying equipment such as belt, rotary drum, and spray dryer. The drying can be direct or indirect. The drying heat can be from steam, heated air, combustion of natural gas or oil, electrical element, and IR/microwave element. The produced lignin can have a yield of 70-75%, a high purity (ash content as low as 0.05-0.25%, sodium content as low as 30-250 ppm, and sulfur content as low as 2.0-2.5%), low polydispersity (3.0-3.5 Mw/Mn), and insignificant smell.

Optionally, the filtrate from the washer 450 is sent to waste water treatment. If needed, sodium hydroxide is added to the filtrate or filtrates to raise the pH of the filtrate to a pH of 7 to 8.

### Comparison and Examples

The example FLiP processes described herein have a number of operational advantages over known processes.

First, the FLiP processes can be fully integrated with a typical pulp mill. The processes have lower capital cost than other processes because they generally require smaller and simpler equipment due to short retention times and high filtration rate of lignin solids. This reduces the initial cost of equipment, cost of installation, and reduced cost of maintenance.

Certain disclosed processes recycle waste materials produced by the pulp mill. For example, in certain embodiments the ion source is the acidic salt cake from a mill chlorine dioxide generator. The salt cake would normally be added to the weak black liquor tank as waste. The acidic salt cake is an ideal replacement of purchased acid for the disclosed lignin precipitation processes. The sulfuric acid in the acidic salt cake reduces pH and sodium sulfate in the acidic salt cake increases ion content, both of which promote lignin precipitation and particle formation as set forth in certain disclosed embodiments. Moving the salt cake addition point from the weak black liquor tank to the lignin precipitation process reduces the amount of acid (e.g., sulfuric acid) that needs to be purchased and reduces waste.

A second recycling process involves sodium hydroxide, which is typically a mill waste product. In certain disclosed embodiments where base is added at any point (e.g., in FLiP4, FIG. 3, between the washer 350 and the displacement filter 330), instead of adding new chemicals, waste sodium hydroxide from the mill can be used. The processes also result in improved efficiency. The process conditions result in a fast lignin precipitation, optimal particle formation, high washing efficiency, and stable operation. The processes have less impact on the pulp mill operation. The processes have minimal impact on the sodium and sulfur balance of the pulp mill and low discharge of organic compounds (BOD/COD) to the mill's waste water treatment plant.

FLiP4, 5, and 6 generate less total reduced sulfur (TRS) including H₂S from the acidification of the dirty cake. Sulfide (S²⁻) is converted to H₂S during the acidification. Most of the sulfide ions and TRS compounds in the residual filtrate of the dirty cake are removed through the displacement filter.

In other aspects, lignin produced by the disclosed methods is provided. The specific qualities of exemplary lignin formed using the FLiP methods are disclosed in the above descriptions and below EXAMPLES. The following examples are included for the purpose of illustrating, not limiting, the disclosed embodiments.

### Examples

### Example 1

### FLiP1/2

In all of the samples (Sam.) the black liquor (BL) is from the Weyerhaeuser New Bern, N.C. pulp mill. The solids content of the black liquor is 45%. In the wash cycle, each wash stage is given as the amount of wash liquid in milliliters (ml) or liters (L), the pH of the wash liquid and the temperature of the wash liquid. The numbers below the sample number represent the internal experimental identification.

Lignin solids generated from all of the samples have several common characteristics, including: 1) granular particles, 2) low density, 3) high filtration rate, 4) high purity, 5) insignificant smell, and 6) reduced dust.

Table 1

In the samples in Table 1, a 2 liter kettle is used. The amount of black liquor is given in grams (g). The Add time is the time required to add the sulfuric acid with a burette. The pH is the pH of the treated black liquor after the addition of the acid. The temperature of the treated black liquor is 75° C. The kettle is agitated at 300 rpm. Aging is the dwell time in the kettle after the addition of materials.

Filtration is with a 15 cm Buchner funnel and a #4 filter paper (#4) or with a lab scale Larox press which is pumped until there is no substantial filtrate.

In the Sample 2 there was pressing of the sample between wash stages.

The lignin is air dried.

Table 2

The measured results of the samples for the samples in Table 1 are listed in Table 2. Sugar represents the total amount of carbohydrates in the product lignin.

Table 3

In the samples in Table 3, a 3 liter kettle is used. The sulfuric acid (H₂SO₄) is given in g. The sulfuric acid is mixed with water and the mixture is added to the black liquor to adjust the pH. The pH is the pH of the treated black liquor after the addition of the acidic solution. The temperature is the temperature of the black liquor before and during treatment. The kettle is agitated at 300 rpm. Aging is the dwell time in the kettle after the addition of the acidic materials.

Filtration is with a 15 cm Buchner funnel and a #4 filter paper (#4).

The lignin is air dried.

Table 4

The measured results of the samples for the samples in Table 3 are listed in Table 4. Tg represents the glass transition temperature measured with DSC (Differential Scanning calorimetry). Tm represents the temperature at which the mass loss rate is at the maximum measured with TGA (Thermogravimetric Analyzer).

Table 5

In the samples in Table 5, a 3 liter kettle is used. The amount of black liquor and the amount of Na₂SO₄ are given in grams (g). The sulfuric acid (H₂SO₄) is given in ml. The first sulfuric acid is mixed with sodium sulfate and water to form a solution and the mixture is added to the black liquor. Add is the time to add the acidic material to the black liquor with a burette. The second sulfuric acid is used to adjust the pH of the treated black liquor. The second Add column is the time required to add the second sulfuric acid to the black liquor. The pH is the pH of the treated black liquor after the addition of acidic materials. The temperature of the treated black liquor is 75° C. The kettle is agitated at 300 rpm. Aging is the dwell time in the kettle after the addition of acidic materials.

Filtration is with a lab scale Larox press which is pumped until there is no substantial filtrate.

The lignin is air dried.

Table 6

The measured results of the samples for the samples in Table 5 are listed in Table 6.

Table 7

In the samples in Table 7, a 3 liter kettle is used. The amount of black liquor and the amount of Na₂SO₄ are given in grams (g). The sulfuric acid (H₂SO₄) is given in ml. The sulfuric acid is mixed with sodium sulfate and water to form a solution. The mixture and the black liquor are continuously mixed through an in-line mixer and pumped into the kettle. The pH is the pH of the treated black liquor. The temperature of the treated black liquor is 75° C. The kettle is agitated at 300 rpm.

Filtration is with a lab scale Larox press which is pumped until there is no substantial filtrate.

The lignin is air dried after washing.

Table 8

The measured results of the samples for the samples in Table 7 are listed in Table 8.

Table 9

In the samples in Table 9, a 60 liter kettle is used. The amount of black liquor is in kilograms, the amount of sulfuric acid (H₂SO₄) is given in grams, and the amount of sodium sulfate (Na₂SO₄) is given in grams. The sulfuric acid is mixed with sodium sulfate and water to form a solution and the mixture is added to the black liquor. The temperature of the treated black liquor is 75° C. Aging is the dwell time in the kettle.

Filtration is with a large funnel.

The lignin is air dried after washing.

Table 10

The measured results of the samples for the samples in Table 9 are listed in Table 10. Sugar represents the total amount of carbohydrates in the product lignin. Tg represents the glass transition temperature measured with DSC (Differential Scanning calorimetry).

Table 11

In the samples in Table 11, a 3 liter kettle is used. The amount of black liquor is in grams, the amount of sulfuric acid (H₂SO₄) is given in grams, and the salt cake solution is in ml. The sulfuric acid is mixed with the salt cake solution to form a solution and the mixture is added to the black liquor. The Add time is the time required to add the mixture with a burette. The temperature of the treated black liquor is 75° C. The kettle is agitated at 300 rpm. Aging is the dwell time in the kettle.

Filtration is with a 15 cm Buchner funnel and a #4 filter paper (#4).

The lignin is air dried after washing.

Table 12

The measured results of the samples for the samples in Table 11 are listed in Table 12. Tg represents the glass transition temperature measured with DSC (Differential Scanning calorimetry). Tm represents the temperature at which the mass loss rate is at the maximum measured with TGA (Thermogravimetric Analyzer).

TABLE 1

| | | | | | | | Wash | | | |
|---|---|---|---|---|---|---|---|---|---|---|
| | | H₂SO₄ | | | | | ml | | | |
| | | 4N | | | | | pH | | | |
| Sam. | BL g | ml | Add min | pH | Age min | Filter | ° C. | | | |
| 1 | 626 | 620 | 46 | 2.5 | 60 | 15 cm | 150 | 150 | 150 | 150 |
| 1-8 | | | | | | | 2.5 | 2.5 | 2.5 | 6-7 |
| | | | | | | | 25 | 25 | 25 | 25 |
| 2 | 625 | 640 | 30 | 2.48 | 30 | Larox | 500 | press | 100 | press |
| 1-15 | | | | | | | 2.5 | | 6-7 | |
| | | | | | | | 50 | | 50 | |

TABLE 2

| | Ash | Sulfur | Sodium | Sugar |
|---|---|---|---|---|
| Sam. | % OD | % OD | ppm | % OD |
| 1 | 0.3 | 4.68 | 550 | 1.33 |
| 1-8 | | | | |
| 2 | 0.34 | 4.38 | 820 | 1.31 |
| 1-15 | | | | |

TABLE 3

| | | | | | | | | Wash | |
|---|---|---|---|---|---|---|---|---|---|
| | | | | | | | | ml | |
| | | H₂SO₄ | | | | | | pH | |
| Sam. | BL g | 93% g | H₂O ml | Add min | pH | Age min | Filter | ° C. | |
| 3 | 626 | 120 | 775 | 20 | 2.42 | 60 | 15 cm | 1500 | 1500 |
| 5-42 | | | | | | | | 1.5 | 6-7 |
| | | | | | | | | 75 | 75 |

TABLE 4

| | Ash | Sulfur | Sodium | Tg | Tm |
|---|---|---|---|---|---|
| Sam. | % OD | % OD | ppm | ° C. | ° C. |
| 3 | 0.2 | 4.00 | 700 | 112.53 | 582.80 |
| 5-42 | | | | | |

TABLE 5

| | | | | | | | | | | | Wash | | |
|---|---|---|---|---|---|---|---|---|---|---|---|---|---|
| | | H₂SO₄ | | | | H₂SO₄ | | | | | ml | | |
| | | 4N | | H₂O | Add | 4N | Add | | Age | | pH | | |
| Sam. | BL g | ml | Na₂SO₄ g | ml | min | ml | min | pH | min | Filter | ° C. | | |
| 4 | 601 | 210 | 181 | 300 | 17 | 180 | 10 | 5.08 | 60 | Larox | 500 | 1000 | 500 |
| 3-14 | | | | | | | | | | | 6-7 | 1.5 | 6-7 |
| | | | | | | | | | | | 75 | 75 | 75 |
| 5 | 600 | 210 | 181 | 300 | 10 | 185 | 17 | 5.06 | 60 | Larox | 500 | 2000 | 500 |
| 3-15 | | | | | | | | | | | 6-7 | 1.5 | 6-7 |
| | | | | | | | | | | | 75 | 75 | 90 |

TABLE 6

| | Ash | Sulfur | Sodium |
|---|---|---|---|
| Sam. | % OD | % OD | ppm |
| 4 | 0.38 | 3.41 | 670 |
| 3-14 | | | |
| 5 | 0.05 | 3.6 | 90 |
| 3-15 | | | |

TABLE 7

| | | | | | | | | | Wash | | |
|---|---|---|---|---|---|---|---|---|---|---|---|
| | | H₂SO₄ | | | | | | | ml | | |
| | | 4N | | H₂O | Add | | Age | | pH | | |
| Sam. | BL g | ml | Na₂SO₄ g | ml | min | pH | min | Filter | ° C. | | |
| 6 | 600 | 410 | 181 | 300 | Cont. | 5.0 | 30 | Larox | 500 | 2000 | 500 |
| 4-2 | | | | | mix | | | | 6-7 | 1.5 | 6-7 |
| | | | | | | | | | 75 | 75 | 75 |
| 7 | 600 | 410 | 181 | 300 | Cont. | 5.0 | 20 | Larox | 500 | 2000 | 500 |
| 4-3 | | | | | mix | | | | 6-7 | 1.5 | 6-7 |
| | | | | | | | | | 75 | 75 | 75 |
| 8 | 600 | 410 | 181 | 300 | Cont. | 5.0 | 10 | Larox | 500 | 2000 | 500 |
| 4-4 | | | | | mix | | | | 6-7 | 1.5 | 6-7 |
| | | | | | | | | | 75 | 75 | 75 |

TABLE 8

| | Ash | Sulfur | Sodium |
|---|---|---|---|
| Sam. | % OD | % OD | ppm |
| 6 | 0.59 | 4.55 | 870 |
| 4-2 | | | |
| 7 | 0.26 | 5.88 | 470 |
| 4-3 | | | |
| 8 | 0.09 | 4.87 | 100 |
| 4-4 | | | |

TABLE 9

| | | | | | | | | | Wash | | | |
|---|---|---|---|---|---|---|---|---|---|---|---|---|
| | | H₂SO₄ | | | | | | | L | | | |
| | BL | 93% | Na₂SO₄ | H₂O | Add | | Age | | pH | | | |
| Sam. | kg | g | g | L | min | pH | min | Filter | ° C. | | | |
| 9 | 9.69 | 1399 | 2923 | 11.5 | 14 | 4.76 | 60 | 18.5 | 8 | 8 | 8 | 8 |
| L-2 | | | | | | | | inch | 6-7 | 1.5 | 1.5 | 6-7 |
| | | | | | | | | | 75 | 75 | 75 | 75 |
| 10 | 4.9 | 698 | 1462 | 5.7 | 5 | 4.76 | 60 | 18.5 | 4 | 4 | 4 | 4 |
| L-3 | | | | | | | | inch | 6-7 | 1.5 | 1.5 | 6-7 |
| | | | | | | | | | 75 | 75 | 75 | 75 |

TABLE 10

| | Ash | Sulfur | Sodium | Sugar | Tg |
|---|---|---|---|---|---|
| Sam. | % OD | % OD | ppm | % OD | ° C. |
| 9 | 0.14 | 6.02 | 380 | Not measured | Not measured |
| L-2 | | | | | |
| 10 | 0.26 | 4.83 | 170 | 2.24 | 110.18 |
| L-3 | | | | | |

TABLE 11

| | | | Salt Cake | | | | | Wash | |
|---|---|---|---|---|---|---|---|---|---|
| | | H₂SO₄ | Solution | | | | | ml | |
| | BL | 93% | 17% | Add | | Age | | pH | |
| Sam. | g | g | ml | min | pH | min | Filter | ° C. | |
| 11 | 600 | 42 | 935 | 26 | 4.88 | 60 | 15 cm | 1250 | 1250 |
| 5-44 | | | | | | | | 1.5 | 6-7 |
| | | | | | | | | 75 | 75 |

TABLE 12

| | Ash | Sulfur | Sodium | Tg | Tm |
|---|---|---|---|---|---|
| Sam. | % OD | % OD | ppm | ° C. | ° C. |
| 11 | 0.24 | 4.18 | 700 | 127.02 | 540.84 |
| 5-44 | | | | | |

### Example 2

### FLiP3

In all of the samples (Sam.) the black liquor (BL) is from the Weyerhaeuser New Bern, N.C. pulp mill. The solids content of the black liquor is 45%. In the wash cycle each wash stage is given as the amount of wash liquid in milliliters (ml), the pH of the wash liquid and the temperature of the wash liquid. The numbers below the sample number represent the internal experimental identification.

Lignin solids generated from all of the samples have several common characteristics, including: 1) granular particles, 2) low density, 3) high filtration rate, 4) high purity, 5) insignificant smell, and 6) reduced dust.

Table 13

In the samples in Table 13, a 2 liter kettle is used. Table 13 lists the first stage conditions. The amount of black liquor is given in grams (g), the amount of sulfuric acid (H₂SO₄) is given in grams, and the salt cake solution is in ml. The sulfuric acid is mixed with the salt cake solution to form a solution and the solution is added to the black liquor.

The Add time is the time required to add the mixture with a burette. The pH is the pH of the treated black liquor after the addition of the acidic materials. The temperature of the treated black liquor is 75° C. The kettle is agitated at 300 rpm. Aging is the dwell time in the kettle after the addition of materials. Filtration is with a Larox press which is pumped until there is no substantial filtrate. The cake is not washed.

Table 14

Table 14 lists the second stage conditions. The cake from the first stage is broken apart with a laboratory knife and put into a small blender with water. Blending is the time when the blender is on at a medium speed to form the slurry. The slurry is then dumped into the kettle. Add is the time to add the salt cake solution to the slurry with a burette. The pH is the pH of the treated slurry after the addition of salt cake solution. The temperature of the treated black liquor is 75° C. The kettle is agitated at 300 rpm. Aging is the dwell time in the kettle after the addition of acidic materials.

Filtration is with a Larox press which is pumped until there is no substantial filtrate.

The lignin is air dried after washing.

Table 15

The measured results of the samples for the samples in Tables 13 and 14 are listed in Table 15.

Table 16

In the samples in Table 16, a 2 liter kettle is used. Table 16 lists the first stage conditions. The amount of black liquor is given in grams (g) and the amount of sodium sulfate (Na₂SO₄) is given in grams. The sodium sulfate is mixed with water to form a solution and the solution is dumped into the black liquor. Carbon dioxide (CO₂) is added to the black liquor from a cylinder through a sparger. The Add time is the time required to reach the target pH. The pH is the pH of the treated black liquor after the addition of the sodium sulfate solution and CO₂. The temperature of the treated black liquor is 75° C. The kettle is agitated at 300 rpm. Aging is the dwell time in the kettle after the addition of materials. Filtration is with a Larox press which is pumped until there is no substantial filtrate. The cake is not washed.

Table 17

Table 17 lists the second stage conditions. The cake from the first stage is broken apart with a laboratory knife and put into a small blender with water. Blending is the time when the blender is on at a medium speed to form the slurry. The slurry is then dumped into the kettle. Add is the time to add the salt cake solution to the slurry with a burette. The pH is the pH of the treated slurry after the addition of salt cake solution. The temperature of the treated black liquor is 75° C. The kettle is agitated at 300 rpm. Aging is the dwell time in the kettle after the addition of acidic materials.

Filtration is with a Larox press which is pumped until there is no substantial filtrate.

The lignin is air dried after washing.

Table 18

The measured results of the samples for the samples in Tables 16 and 17 are listed in Table 18. Polydispersity is measured with HPLC (High-Performance Liquid Chromatography). Tg represents the glass transition temperature measured with DSC (Differential Scanning calorimetry). Tm represents the temperature at which the mass loss rate is at the maximum measured with TGA (Thermogravimetric Analyzer).

TABLE 13

| | | | Salt Cake | | | | |
|---|---|---|---|---|---|---|---|
| | | H₂SO₄ | Solution | | | | |
| | BL | 93% | 17% | Add | | Age | |
| Sam. | g | g | ml | min | pH | min | Filter |
| 1 | 603 | 18.4 | 460 | 8 | 8.9 | 60 | Larox |
| 5-58 | | | | | | | |
| 2 | 601 | 17.5 | 487 | 18 | 8.9 | 60 | Larox |
| 5-59 | | | | | | | |

TABLE 14

| | | | Salt Cake | | | | | Wash | |
|---|---|---|---|---|---|---|---|---|---|
| | | | Solution | | | | | ml | |
| | H₂O | Blending | 17% | Add | | Age | | pH | |
| Sam. | ml | min | ml | min | pH | min | Filter | ° C. | |
| 1 | 500 | 3 | 428 | 14 | 2.5 | 60 | Larox | 1500 | 1200 |
| 5-58 | | | | | | | | 1.5 | 6-7 |
| | | | | | | | | 75 | 75 |
| 2 | 200 | 3 | 365 | 8 | 2.49 | 60 | Larox | 1500 | 1500 |
| 5-59 | | | | | | | | 1.5 | 6-7 |
| | | | | | | | | 75 | 75 |

TABLE 15

| | Ash % | Sulfur | Sodium |
|---|---|---|---|
| Sam. | OD | % OD | ppm |
| 1 | 0.04 | 1.78 | 70 |
| 5-58 | | | |
| 2 | 0.04 | 1.35 | 110 |
| 5-59 | | | |

TABLE 16

| | BL | Na₂SO₄ | H₂O | | Add | | Age | |
|---|---|---|---|---|---|---|---|---|
| Sam. | g | g | ml | CO₂ | min | pH | min | Filter |
| 3 | 600 | 45 | 300 | As needed | 25 | 9.08 | 60 | Larox |
| 5-67 | | | | | | | | |
| 4 | 600 | 45 | 300 | As needed | 21 | 8.9 | 60 | Larox |
| 5-69 | | | | | | | | |

TABLE 17

| | | | Salt Cake | | | | | Wash | |
|---|---|---|---|---|---|---|---|---|---|
| | | | Solution | | | | | ml | |
| | H₂O | Blending | 17% | Add | | Age | | pH | |
| Sam. | ml | min | ml | min | pH | min | Filter | ° C. | |
| 3 | 100 | 3 | 675 | 60 | 2.54 | 60 | Larox | 1500 | 1200 |
| 5-67 | | | | | | | | 1.5 | 6-7 |
| | | | | | | | | 75 | 75 |
| 4 | 100 | 3 | 570 | 22 | 2.44 | 60 | Larox | 1500 | 1500 |
| 5-69 | | | | | | | | 1.5 | 6-7 |
| | | | | | | | | 75 | 75 |

TABLE 18

| | Ash | Sulfur | Sodium | Poly- | Tg | Tm |
|---|---|---|---|---|---|---|
| Sam. | % OD | % OD | ppm | dispersity | ° C. | ° C. |
| 3 | 0.29 | 1.82 | 720 | Not | Not | Not |
| 5-67 | | | | measured | measured | measured |
| 4 | 0.39 | 1.70 | 1020 | 4.1 | 112.69 | 531.15 |
| 5-69 | | | | | | |

### Example 3

### FLiP4

In all of the samples (Sam.) the black liquor (BL) is from the Weyerhaeuser New Bern, N.C. pulp mill. The solids content of the black liquor is 45%. In the wash cycle each wash stage is given as the amount of wash liquid in milliliters (ml) or liters (L), the pH of the wash liquid and the temperature of the wash liquid. The numbers below the sample number represent the internal experimental identification.

Lignin solids generated from all of the samples have several common characteristics, including: 1) granular particles, 2) low density, 3) high filtration rate, 4) high purity, 5) insignificant smell, and 6) reduced dust.

Table 19

In the samples in Table 19, a 2 liter kettle is used. Table 19 lists the first stage conditions. The amount of black liquor is given in grams (g), the amount of sulfuric acid (H₂SO₄) is given in grams, and the salt cake solution is in ml. The sulfuric acid is mixed with the salt cake solution to form a solution and the solution is added to the black liquor. The Add time is the time required to add the mixture with a burette. The pH is the pH of the treated black liquor after the addition of the acidic materials. The temperature of the treated black liquor is 75° C. The kettle is agitated at 300 rpm. Aging is the dwell time in the kettle after the addition of materials. Filtration is with a 15 cm Buchner funnel and a #4 filter paper (#4). The wash liquor is formed by mixing water and sodium sulfate.

Table 20

Table 20 lists the second stage conditions. The cake from the first stage is broken apart with a laboratory knife and put into a small blender with water. Blending is the time when the blender is on at a medium speed to form the slurry. The slurry is then dumped into the kettle. Add is the time to add the salt cake solution to the slurry with a burette. The pH is the pH of the treated slurry after the addition of salt cake solution. The temperature of the treated black liquor is 75° C. The kettle is agitated at 300 rpm. Aging is the dwell time in the kettle after the addition of acidic materials.

Filtration is with a 15 cm Buchner funnel and a #4 filter paper (#4).

The lignin is air dried after washing.

Table 21

The measured results of the samples for the samples in Tables 19 and 20 are listed in Table 21. Tg represents the glass transition temperature measured with DSC (Differential Scanning calorimetry). Tm represents the temperature at which the mass loss rate is at the maximum measured with TGA (Thermogravimetric Analyzer).

Table 22

In the samples in Table 22, a 2 liter kettle is used. Table 22 lists the first stage conditions. The amount of black liquor is given in grams (g) and the amount of sodium sulfate (Na₂SO₄) is given in grams. The sodium sulfate is mixed with water to form a solution and the solution is dumped into the black liquor. Carbon dioxide (CO₂) is added to the black liquor from a cylinder through a sparger. The Add time is the time required to reach the target pH. The pH is the pH of the treated black liquor after the addition of the sodium sulfate solution and CO₂. The temperature of the treated black liquor is 75° C. The kettle is agitated at 300 rpm. Aging is the dwell time in the kettle after the addition of materials. Filtration is with a Larox press which is pumped until there is no substantial filtrate. The wash liquor is formed by mixing water and sodium sulfate.

Table 23

Table 23 lists the second stage conditions. The cake from the first stage is broken apart with a laboratory knife and put into a small blender with water. Blending is the time when the blender is on at a medium speed to form the slurry. The slurry is then dumped into the kettle. Add is the time to add the salt cake solution to the slurry with a burette. The pH is the pH of the treated slurry after the addition of salt cake solution. The temperature of the treated black liquor is 75° C. The kettle is agitated at 300 rpm. Aging is the dwell time in the kettle after the addition of acidic materials.

Filtration is with a Larox press which is pumped until there is no substantial filtrate.

The lignin is air dried after washing.

Table 24

The measured results of the samples for the samples in Tables 22 and 23 are listed in Table 24. Polydispersity is measured with HPLC (High-Performance Liquid Chromatography). Tg represents the glass transition temperature measured with DSC (Differential Scanning calorimetry). Tm represents the temperature at which the mass loss rate is at the maximum measured with TGA (Thermogravimetric Analyzer).

TABLE 19

| | | | Salt Cake | | | | | Wash | |
|---|---|---|---|---|---|---|---|---|---|
| | | H₂SO₄ | Solution | | | | | ml | |
| | BL | 93% | 17% | Add | | Age | | pH | |
| Sam. | g | g | ml | min | pH | min | Filter | ° C. | |
| 1 | 600 | 18.0 | 450 | 10 | 9.0 | 60 | 15 cm | 1000 | 100 |
| 5-45 | | | | | | | | 9.0 | g |
| | | | | | | | | 75 | Na₂SO₄ |

TABLE 20

| | | Salt Cake | | | | | Wash | |
|---|---|---|---|---|---|---|---|---|
| | | Solution | | | | | ml | |
| | H₂O | 17% | Add | | Age | | pH | |
| Sam. | ml | ml | min | pH | min | Filter | ° C. | |
| 1 | 100 | 250 | Added | 2.3 | 60 | 15 cm | 1500 | 1200 |
| 5-45 | | | cake to | | | | 1.5 | 6-7 |
| | | | solu- | | | | 75 | 75 |
| | | | tion | | | | | |

TABLE 21

| | Ash | Sulfur | Sodium | Tg | Tm |
|---|---|---|---|---|---|
| Sam. | % OD | % OD | ppm | ° C. | ° C. |
| 1 | 0.25 | 1.55 | 520 | 134.13 | 534.38 |
| 5-45 | | | | | |

TABLE 22

| | | | | | | | | | Wash | |
|---|---|---|---|---|---|---|---|---|---|---|
| | | | | | | | | | ml | |
| | BL | Na₂SO₄ | H₂O | | Add | | Age | | pH | |
| Sam. | g | g | ml | CO₂ | min | pH | min | Filter | ° C. | |
| 2 | 600 | 45 | 300 | As needed | 35 | 9.08 | 60 | Larox | 150 | 20 |
| 5-65 | | | | | | | | | 9.0 | g |
| | | | | | | | | | 75 | Na₂SO₄ |

TABLE 23

| | | | Salt Cake | | | | | Wash | |
|---|---|---|---|---|---|---|---|---|---|
| | | | Solution | | | | | ml | |
| | H₂O | Blending | 17% | Add | | Age | | pH | |
| Sam. | ml | min | ml | min | pH | min | Filter | ° C. | |
| 2 | 100 | 3 | 420 | 15 | 2.53 | 60 | Larox | 1500 | 1200 |
| 5-65 | | | | | | | | 1.5 | 6-7 |
| | | | | | | | | 75 | 75 |

TABLE 24

| | Ash | Sulfur | Sodium | Poly- | Tg | Tm |
|---|---|---|---|---|---|---|
| Sam. | % OD | % OD | ppm | dispersity | ° C. | ° C. |
| 2 | 0.11 | 1.37 | 280 | 4.6 | 134.21 | 565.05 |
| 5-65 | | | | | | |

### Example 5

### FLIP5/6

In all of the samples (Sam.) the black liquor (BL) is from the Weyerhaeuser New Bern, N.C. pulp mill. The solids content of the black liquor is 45%. In the wash cycle each wash stage is given as the amount of wash liquid in milliliters (ml) or liters (L), the pH of the wash liquid and the temperature of the wash liquid. The numbers below the sample number represent the internal experimental identification.

Lignin solids generated from all of the samples have several common characteristics, including: 1) granular particles, 2) low density, 3) high filtration rate, 4) high purity, 5) insignificant smell, and 6) reduced dust.

Table 25

In the samples in Table 25, a 2 liter kettle is used. The amount of black liquor is given in grams (g), the amount of sodium sulfate (Na₂SO₄) is given in grams, and the salt cake solution is in ml. The sodium sulfate is mixed with water to form a solution and the solution is dumped into the black liquor. The Add time is the time required to add the salt cake solution with a burette. Carbon dioxide (CO₂) is added to the black liquor from a cylinder through a sparger. The Add time is the time required to reach the target pH. The pH is the pH of the treated black liquor after the addition of the acidic materials. The temperature of the treated black liquor is 75° C. The kettle is agitated at 300 rpm. Aging is the dwell time in the kettle after the addition of materials.

Filtration is with a Larox press which is pumped until there is no substantial filtrate. The wash liquor is formed by adjusting the pH of water with a sodium hydroxide (NaOH) solution.

Table 26

Table 26 lists the second stage conditions. The cake from the first stage is broken apart with a laboratory knife and put into a small blender with water. Blending is the time when the blender is on at a medium speed to form the slurry. The slurry is then dumped into the kettle. Add is the time to add the sulfuric acid (H₂SO₄) solution to the slurry with a burette. The pH is the pH of the treated slurry after the addition of acid. The temperature of the treated black liquor is 75° C. The kettle is agitated at 300 rpm. Aging is the dwell time in the kettle after the addition of acidic materials.

Filtration is with a 15 cm Buchner funnel and a #4 filter paper (#4) for Sample 1 and Larox press for other samples.

The lignin is air dried after washing.

Table 27

The measured results of the samples for the samples in Tables 25 and 26 are listed in Table 27. Polydispersity is measured with HPLC (High-Performance Liquid Chromatography). Tg represents the glass transition temperature measured with DSC (Differential Scanning calorimetry). Tm represents the temperature at which the mass loss rate is at the maximum measured with TGA (Thermogravimetric Analyzer).

TABLE 25

| | | | | Salt Cake | | | | | | | Wash |
|---|---|---|---|---|---|---|---|---|---|---|---|
| | | | | Solution | | | | | | | ml |
| | BL | H₂O | Na₂SO₄ | 17% | Add | | Add | | Age | | pH |
| Sam. | g | ml | g | ml | min | CO₂ | min | pH | min | Filter | ° C. |
| 1 | 600 | 100 | 20.0 | 150 | 12 | As needed | 38 | 9.08 | 60 | Larox | 150 |
| 5-66 | | | | | | | | | | | 9.0 |
| | | | | | | | | | | | 75 |
| 2 | 604 | 100 | 20.0 | 150 | 4 | As needed | 20 | 8.93 | 60 | Larox | 100 |
| 5-68 | | | | | | | | | | | 9.0 |
| | | | | | | | | | | | 75 |
| 3 | 601 | 0 | 0 | 150 | 12 | As needed | 20 | 8.95 | 60 | Larox | 100 |
| 5-70 | | | | | | | | | | | 9.0 |
| | | | | | | | | | | | 75 |
| 4 | 602 | 100 | 20.0 | 0 | N/A | As needed | 30 | 9.0 | 60 | Larox | 100 |
| 5-71 | | | | | | | | | | | 9.0 |
| | | | | | | | | | | | 75 |
| 5 | 600 | 150 | 0 | 0 | N/A | As needed | 50 | 9.0 | 60 | Larox | 100 |
| 5-72 | | | | | | | | | | | 9.0 |
| | | | | | | | | | | | 75 |

TABLE 26

| | | | | | | | | Wash | |
|---|---|---|---|---|---|---|---|---|---|
| | | | H₂SO₄ | | | | | ml | |
| | H₂O | Blending | 4N | Add | | Age | | pH | |
| Sam. | ml | min | ml | min | pH | min | Filter | ° C. | |
| 1 | 400 | 3 | 57 | 5 | 2.43 | 60 | 15 cm | 1500 | 1500 |
| 5-66 | | | | | | | | 1.5 | 6-7 |
| | | | | | | | | 75 | 75 |
| 2 | 500 | 3 | 62 | 8 | 2.42 | 60 | Larox | 1500 | 1500 |
| 5-68 | | | | | | | | 1.5 | 6-7 |
| | | | | | | | | 75 | 75 |
| 3 | 500 | 3 | 70 | 10 | 2.47 | 60 | Larox | 1500 | 1500 |
| 5-70 | | | | | | | | 1.5 | 6-7 |
| | | | | | | | | 75 | 75 |
| 4 | 500 | 3 | 76 | 13 | 2.50 | 60 | Larox | 1500 | 1500 |
| 5-71 | | | | | | | | 1.5 | 6-7 |
| | | | | | | | | 75 | 75 |
| 5 | 500 | 3 | 81 | 11 | 2.41 | 60 | Larox | 1500 | 1500 |
| 5-72 | | | | | | | | 1.5 | 6-7 |
| | | | | | | | | 75 | 75 |

TABLE 27

| | Ash | Sulfur | Sodium | Poly- | Tg | Tm |
|---|---|---|---|---|---|---|
| Sam. | % OD | % OD | ppm | dispersity | ° C. | ° C. |
| 1 | 0.04 | 1.66 | 60 | 4.2 | 116.00 | 577.96 |
| 5-66 | | | | | | |
| 2 | 0.04 | 1.64 | 140 | 4.2 | 112.32 | 588.45 |
| 5-68 | | | | | | |
| 3 | 0.19 | 1.8 | 490 | Not | Not | Not |
| 5-70 | | | | measured | measured | measured |
| 4 | 0.09 | 1.95 | 270 | Not | Not | Not |
| 5-71 | | | | measured | measured | measured |
| 5 | 0.13 | 1.95 | 290 | Not | Not | Not |
| 5-72 | | | | measured | measured | measured |

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of separating lignin from black liquor, comprising the steps of:
(a) adjusting the pH of the black liquor to between about 8.5 and about 10.0 to provide a basic lignin suspension;
(b) displacing liquid from the basic lignin suspension with a first water solution to provide dirty cake lignin;
(c) comminuting the dirty cake lignin with a comminuting acidic material to provide an acidic lignin suspension having a pH between about 1.5 and about 6.0 and an ion concentration between about 0.1 and about 0.5 M; and
(d) precipitating the acidic lignin suspension to provide lignin solids.

2. The method of claim 1, further comprising a step of washing the lignin solids to provide clean cake lignin.

3. The method of claim 2, wherein the step of washing the lignin solids results in an acidic filtrate that is adjusted to a pH above about 7 with a basic solution and used as the first water solution in the step of displacing liquid from the basic lignin suspension.

4. The method of claim 1, wherein the step of displacing liquid from the basic lignin suspension produces an alkaline filtrate.

5. The method of claim 4, wherein the alkaline filtrate is used in the step of adjusting the pH of the black liquor.

6. The method of claim 4, wherein the step of adjusting the pH of the black liquor comprises sequentially and separately adding an alkaline material and an acidic material to the black liquor, and wherein the alkaline material is the alkaline filtrate.

7. The method of claim 1, further comprising a step of comminuting the lignin solids.

8. The method of claim 1, further comprising a step of adding a source of ions to the black liquor before the step of adjusting the pH of the black liquor.

9. The method of claim 7, wherein the source of ions is an inorganic salt.

10. A method of separating lignin from black liquor, comprising the steps of:
(a) adjusting the pH of the black liquor to between about 8.5 and about 10.0 to provide a basic lignin suspension;
(b) displacing liquid from the basic lignin suspension with a first water solution to provide dirty cake lignin;
(c) comminuting the dirty cake lignin with a comminuting acidic material to provide an acidic lignin suspension having a pH between about 1.5 and about 6.0, wherein the comminuting acidic material is a source of ions and the acidic lignin suspension has an ion concentration between about 0.5 and about 6.0 M; and
(d) precipitating the acidic lignin suspension to provide lignin solids.

11. The method of claim 10, further comprising a step of washing the lignin solids to provide clean cake lignin.

12. The method of claim 10, wherein the step of displacing liquid from the basic lignin suspension produces an alkaline filtrate.

13. The method of claim 12, wherein the alkaline filtrate is used in the step of adjusting the pH of the black liquor.

14. The method of claim 12, wherein the step of adjusting the pH of the black liquor comprises sequentially and separately adding an alkaline material and an acidic material to the black liquor, and wherein the alkaline material is the alkaline filtrate.

15. A method of separating lignin from black liquor, comprising the steps of:
(a) adding a source of ions to a black liquor stream to provide ion-rich black liquor having an ion concentration between about 1.5 and about 7.0 M;
(b) adjusting the pH of the ion-rich black liquor to between about 1.5 and about 6.0 to provide an acidic lignin suspension; and
(c) precipitating the acidic lignin suspension to provide lignin solids.

16. The method of claim 15, wherein the step of precipitating the acidic lignin suspension to provide lignin solids comprises holding the acidic lignin suspension for a hold time.

17. A method of separating lignin from black liquor, comprising the steps of:
(a) adjusting the pH of the black liquor to between about 8.5 and about 10.0 to provide a basic lignin suspension;
(b) separating lignin from the basic lignin suspension to provide dirty cake lignin;
(c) comminuting the dirty cake lignin with a comminuting acidic material to provide an acidic lignin suspension having a pH between about 1.5 and about 6.0, wherein the comminuting acidic material is a source of ions and the acidic lignin suspension has an ion concentration between about 0.5 and about 6.0 M; and
(d) precipitating the acidic lignin suspension to provide lignin solids.

18. The method of claim 17, wherein the step of washing the lignin solids produces an acidic filtrate.

19. The method of claim 18, wherein the acidic filtrate is used in the step of adjusting the pH of the black liquor.

20. The method of claim 18, wherein the step of adjusting the pH of the black liquor comprises sequentially and separately adding a first acidic material and a second acidic material to the black liquor, and wherein one of the first acidic material and the second acidic material is the acidic filtrate.
